(19) United States
(12) Patent Application Publication
(10) Pub. No.: US 2014/0262265 A1
(43) Pub. Date: Sep. 18, 2014

(54) WELL STIMULATION WITH GAS HYDRATES

(71) Applicant: SCHLUMBERGER TECHNOLOGY CORPORATION, Sugar Land, TX (US)

(72) Inventors: Richard D. Hutchins, Sugar Land, TX (US); Alejandro Pena, Katy, TX (US); William Troy Huey, Fulshear, TX (US); Philippe Enkababian, Richmond, TX (US); George Waters, Oklahoma City, OK (US); Andrey Mirakyan, Katy, TX (US); Salvador Ayala, Houston, TX (US); J. Ernest Brown, Sugar Land, TX (US); Heng-Joo Ng, Edmonton (CA)

(73) Assignee: SCHLUMBERGER TECHNOLOGY CORPORATION, Sugar Land, TX (US)

(21) Appl. No.: 14/208,770

(22) Filed: Mar. 13, 2014

Related U.S. Application Data
(60) Provisional application No. 61/788,960, filed on Mar. 15, 2013.
(60) Provisional application No. 61/875,443, filed on Sep. 9, 2013.

(51) Int. Cl. C09K 8/92; E21B 43/267

(52) U.S. Cl. CPC C09K 8/92; E21B 43/267
USPC 166/280.2; 166/305.1; 166/308.2; 507/202

(57) ABSTRACT

Various methods for performing treatment operations at a wellsite having a subterranean formation with a reservoir therein are provided. The method involves introducing a treatment fluid comprised of at least a gas hydrate slurry to the subterranean formation.

This application claims the benefit of U.S. Provisional Application Ser. No. 61/788,960 filed Mar. 15, 2013 entitled “Well Stimulation With Gas Hydrates” to Hutchins et al. (Attorney Docket No. IS13.3317-US-PSP), and U.S. Provisional Application Ser. No. 61/875,443 filed Sep. 9, 2013 entitled “Well Stimulation With Gas Hydrates” to Hutchins et al. (Attorney Docket No. IS13.3793-US-PSP), the disclosure of each provisional application is incorporated by reference herein in their entirety.

### BACKGROUND

Hydrocarbons (oil, natural gas, etc.) are obtained from a subterranean geologic formation (a “reservoir”) by drilling a well that penetrates the hydrocarbon-bearing formation. In the process of recovering hydrocarbons from subterranean formations, it is common practice to treat a hydrocarbon-bearing formation with a pressurized fluid to provide flow channels, i.e., to fracture the formation, or to use such fluids to control sand to facilitate flow of the hydrocarbons to the wellbore.

Well treatment fluids, particularly those used in fracturing, typically comprise water- or oil-based fluid incorporating a thickening agent, normally a polymeric material. Typical polymeric thickening agents for use in such fluids comprise galactomannan gums, such as guar and substituted guars such as hydroxypropyl guar (HPG) and carboxymethylhydroxypropyl guar (CMHPG). Cellulosic polymers such as hydroxyethyl cellulose may also be used, as well as synthetic polymers such as polyacrylamide. Sometimes guar is modified with ionic groups to facilitate hydration of the polymer and to improve crosslinking with metal complexes. Ionic modification of the polymers can reduce the time it takes to dissolve the dry polymer at the well site, and improve both the ultimate gel strength and the thermal persistence of the gel upon crosslinking with a metal crosslinking complex.

In order to prevent the resulting fracture from closing upon release of fluid pressure, typically a hard particulate material known as a proppant may be dispersed in the well treatment fluid to be carried into the resulting fracture and deposited therein. The well treatment fluid should possess a fairly high viscosity, such as, a gel-like consistency, at least when it is within the fracture so that the proppant can be carried as far as possible into the resulting fracture. Moreover, it would be desirable that the well treatment fluid exhibit a relatively low viscosity as it is being pumped down the wellbore, and in addition exhibit a relatively high viscosity when it is within the fracture itself.

Most subterranean formations used for producing oil and gas, coal bed methane, tar sands, oil shale, or shale gas formations may benefit from the application of some form of foam for stimulation to enhance hydrocarbon flow from the formations to make or keep them economically viable. Likewise, most subterranean formations used for fluid storage or disposal may benefit from some form of stimulation to enhance fluid flow into those formations. The fracturing of subterranean formations to stimulate production or enhance injectability includes the pumping of fluids under high pressure through the wells and into the formations with which the wells communicate.

Traditionally, fracturing fluids have been aqueous solutions treated with various chemicals such as surfactants, foamers, cross-linkers and/or gelling agents and often also include proppants such as bauxite, sand or ceramic particulates. The use of aqueous fracturing fluids has certain disadvantages. First, in many parts of the world the water for these fluids is difficult and expensive to obtain.

Other fluids have also been used for fracturing subterranean formations, including: gases such as nitrogen and carbon dioxide; diesel fuel; and liquefied gases such as liquid nitrogen, liquid methane (also referred to as liquefied natural gas or “LNG”) and supercritical carbon dioxide. Hydrocarbon gases and liquids such as methane, ethane, propane, butane, and heavier hydrocarbon solvents have also been injected into wells at sub-fracturing pressures to dissolve heavy oil deposits to stimulate production. Heavier hydrocarbon liquids such as crude oils and derivatives from the refining of crude oil streams such as gasoline, diesel and mineral oil have been injected for the same and/or different purpose. Most of these fluids also have disadvantages.

Although techniques for stimulating subterranean formations have considerably evolved over time, persons skilled in the art continue to search for alternative fracturing fluids and methods.

### SUMMARY

Disclosures relate to compositions and methods for treating subterranean formations, in particular, oilfield stimulation compositions and methods using a gas hydrate slurry.

In some embodiments, the present disclosure relates to a method of treating a subterranean formation penetrated by a wellbore by introducing a treatment fluid comprised of at least a gas hydrate slurry to the subterranean formation.

In some embodiments, the present disclosure relates to a method of treating a subterranean formation penetrated by a wellbore by introducing a treatment fluid comprised of at least a gas hydrate slurry to the subterranean formation. The introduction of the gas hydrate slurry effectively increases the viscosity of the treatment fluid at least from about 2 to about 3 orders of magnitude, which enhances a proppant transport capacity of the treatment fluid.

In some embodiments, the present disclosure relates to a method of treating a subterranean formation penetrated by a wellbore by introducing a first treatment fluid comprised of at least a crosslinkable component, a carrier fluid and a crosslinkable material to the subterranean formation. At least one fracture is then formed within the subterranean formation with the first treatment fluid, and after the forming of the fracture; a second treatment fluid comprised of at least a gas hydrate slurry is introduced to the formation.

### BRIEF DESCRIPTION OF DRAWINGS

FIG. 1 shows the phase diagram for the formation of a methane gas hydrate.

FIG. 2 shows the gas hydrate stability zone (GHSZ) delineated using a temperature versus depth (pressure) profile with respect to the hydrothermal gradient (for subsea gas hydrates), geothermal gradient and the gas hydrate (or clathrate) phase boundary (for subsea sediments).

FIG. 3 illustrates the phase boundary for a methane-water hydrate, along with formulations that also include various inhibitors.

### DETAILED DESCRIPTION

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The statements made herein merely provide information related to the present disclosure and may not constitute prior art, and may describe some embodiments illustrating aspects of the disclosure.

Embodiments of the present disclosure relate generally, but not by way of limitation, to well fracturing and well stimulation operations, and, in particular, to a fracturing fluid and method of fracturing a subterranean formation to stimulate production of fluids from a well, or to improve permeability of the subterranean formation to facilitate injection of fluids into the well.

“Liquefied natural gas” or “LNG” is natural gas that has been processed to remove impurities (for example, nitrogen, water and/or heavy hydrocarbons) and then condensed into a liquid at almost atmospheric pressure by cooling and depressurization.

The term “natural gas” refers to a multi-component gas obtained from a crude oil well (termed associated gas) or from a subterranean gas-bearing formation (termed non-associated gas). The composition and pressure of natural gas can vary. A typical natural gas stream contains methane (CH₄) as a primary component. Raw natural gas will also typically contain ethylene (C₂H₄), ethane (C₂H₆), other hydrocarbons, one or more acid gases (such as carbon dioxide, hydrogen sulfide, carbonyl sulfide, carbon disulfide, and mercaptans), and minor amounts of contaminants such as water, nitrogen, iron sulfide, wax, and crude oil.

For example, U.S. Pat. No. 7,261,158, which is incorporated by reference herein in its entirety, discloses a high concentration gas fracturing composition referred to as “coarse foam”. U.S. Pat. No. 6,844,297, which is incorporated by reference herein in its entirety, discloses fracturing compositions including an amphoteric glycinate surfactant that increases viscosity and enables viscosity control of the compositions through pH adjustment. U.S. Pat. No. 6,838,418, which is incorporated by reference herein in its entirety, discloses fracturing fluid including a polar base, a polyacrylate and an “activator” that ionizes the polyacrylate to a hydroscopic state. U.S. Pat. No. 4,627,495, which is incorporated by reference herein in its entirety, discloses methods using carbon dioxide and nitrogen to create high gas concentration foams. U.S. Pat. No. 7,306,041, which is incorporated by reference herein in its entirety, discloses acid fracturing compositions that contain a gas component. U.S. Patent Application Pub. No. 2007/0204991, which is incorporated by reference herein in its entirety, describes a method and apparatus for fracturing utilizing a combined liquid propane/nitrogen mixture. U.S. Patent Application Pub. No 2006/0065400, which is incorporated by reference herein in its entirety, describes a method for stimulating a formation using liquefied natural gas. U.S. Patent Application Pub. No. 2007/0023184, which is incorporated by reference herein in its entirety, describes a well product recovery process using a gas and a proppant.

Disclosures relate to compositions and methods for treating subterranean formations, in particular, oilfield stimulation compositions and methods, by introducing or injecting one or more gas hydrates into a subterranean formation and stimulating the subterranean formation. The gas hydrates may be in the form of slurry.

Gas hydrates are also referred to as “clathrates”. As used herein, “clathrate” is a weak composite made of a host compound that forms a basic framework and a guest compound that is held in the host framework by inter-molecular interaction, such as hydrogen bonding, Van der Waals forces, and the like. Clathrates may also be called host-guest complexes, inclusion compounds, and adducts. As used herein, “clathrate hydrate” and “gas hydrate” are interchangeable terms used to indicate a clathrate having a basic framework made from water as the host compound. A hydrate is a crystalline solid which looks like ice and forms when water molecules form a three-dimensional cage-like structure around a “hydrate-forming constituent.”

A “hydrate-forming constituent” refers to a compound or molecule in petroleum fluids, including natural gas, which forms hydrate at elevated pressures and/or reduced temperatures. Illustrative hydrate-forming constituents include, but are not limited to, hydrocarbons such as methane, ethane, propane, butane, neopentane, ethylene, propylene, isobutylene, cyclopropane, cyclobutane, cyclopentane, cyclohexane, and benzene, among others. Hydrate-forming constituents can also include non-hydrocarbons, such as oxygen, nitrogen, hydrogen sulfide, carbon dioxide, sulfur dioxide, and chlorine, among others. The low molecular weight hydrocarbons and CO₂ tend to form the clathrate designated as structure I. This likely occurs because of the higher ratio of gas to water in these types of materials. However, the other known structures could be useful as well, such as when a gas mixture or higher-molecular weight hydrocarbon forms the gas phase. Generally speaking, the freons and hydrocarbons with 2 carbons or less often form structure I, as do other materials such CO₂, H₂S, SO₂ and Xe. Hydrocarbons having a molecular weight similar to propane and above tend to form Structure II as the size of these materials may be too large to fit in the smaller cage of structure I. Cyclopropane does fit in structure I due to its smaller size relative to propane. Structure H is seldom found, but may require a mixture of light and heavy hydrocarbons.

The gas hydrates resemble ice but remain solid at temperature and pressure conditions above the freezing point of water. They generally include about 80 to 85 mol % water and 15 to 20 mol % gas. The gas of most hydrates is predominantly methane, with smaller quantities of other light hydrocarbon gases, such as ethane, propane and butanes. These gas hydrates vary in composition depending upon the conditions. At least three crystal structures of hydrates exist, referred to as Structure I, Structure II and Structure H. See, Collett, T. S. and Kuuskraa, V. A., “Hydrates Contain Vast Stores of World Gas Resources,” Oil and Gas Journal, May 11, 1998, pp. 90-95 and Sloan, E. Dendy and Koh, Carolyn A. Clathrate Hydrates of Natural Gases, Third Edition, 2008, which is incorporated by reference herein in its entirety.

In the hydrate lattice of Structure I, the hydrate unit cell includes 46 water molecules that form two small dodecahedral voids and six large tetradecahedral voids that can hold small gas molecules, such as methane and ethane. In Structure II, the hydrate structure includes 16 small dodecahedral and 8 large hexakaidechedral voids formed by 136 water molecules. In Structure II, larger gases can be contained within the voids, such as propane and isobutane. The unit cell of Structure H contains 34 water molecules that form three types of cages—two small cages (each being distinctive from one another) and one larger cage. Structure H hydrates have been suggested to exist in the Gulf of Mexico.

Hydrates tend to form in the pore spaces of sediment layers. However they may also be seen as nodules or deposits of pure hydrate. Gas hydrates are stable at the temperature and pressures found on the ocean floor at depths greater than about 500 m. This depth may vary depending on the conditions of a specific location, for instance, hydrates do not tend to form until a depth of approximately 800 m in the eastern United States. Gas hydrates may also be stable in association with permafrost, both on- and off-shore. Natural gas hydrates act as a gas concentrator in that one unit volume of hydrate is equivalent to about 168 unit volumes of methane gas at standard conditions. Often however, the hydrate itself is dilute in the sediment, occupying 2% of the volume on average.

The formation of gas hydrates (also referred to as “hydrate management”) is often dependent upon three variables: depth, pressure and temperature. FIG. 1 illustrates some of the conditions where methane gas hydrates may form.

As shown in FIG. 1, the water depth and pressure are represented on the vertical axes and temperature is represented on the horizontal axis. The dashed lines separate stability fields of water, water ice, gas and methane gas hydrate. The line labeled “hydrate to gas transition” is the transition line. The conditions to form methane hydrates occur below this line. However, at conditions above this line, methane hydrates typically do not form. As the depth increases, the geotherm line (the change of temperature with depth at a specific location) crosses the hydrate region to the gas transition region. Other gas hydrates besides methane will likely have similar phase diagrams.

The average methane clathrate hydrate composition is 1 mole of methane for 5.75 moles of water. The observed density is around 0.9 g/cm³. For one mole of methane, which has a molar mass of about 16.04 g, we have 5.75 moles of water, with a molar mass of about 18.02 g (see Properties of water), so together for each mole of methane the clathrate complex has a mass of 16.04 g+5.75×18.02 g=119.65 g. The fractional contribution of methane to the mass is then equal to 16.04 g/119.65 g=0.134. The density is around 0.9 g/cm³, so one liter of methane clathrate has a mass of around 0.9 kg, and the mass of the methane contained therein is then about 0.134×0.9 kg=0.1206 kg. At a density as a gas of 0.717 kg/m³ (at 0° C.; see National Institute of Standards and Technology, “Methane” (2011) available at http://webbook.nist.gov/cgi/cbook.cgi?Name=methane&Units=SI&cTG=on&cTC=on&cTP=on#Thermo-Phase), that means a volume of 0.1206/0.717 m³=0.168 m³=168 L. Furthermore, natural gas hydrate slurry can be deliberately formed by mixing natural gas and water at a pressure of about 80-100 bar and a temperature of 2-10° C.

The gas hydrates may be formed at the surface and stored on the surface in a suitable container or vessel prior to being introduced into a well (or wellbore) or a subterranean formation. “Well” or “wellbore” refers to a hole in the subsurface made by drilling or insertion of a conduit into the subsurface. The terms are interchangeable when referring to an opening in the formation. A well may have a substantially circular cross section, or other cross-sectional shapes (for example, circles, ovals, squares, rectangles, triangles, slits, or other regular or irregular shapes). Wells may be cased, cased and cemented, or open-hole, and may be any type, including, but not limited to a producing well, an injection well, an experimental well, and an exploratory well, or the like. A well may be vertical, horizontal, or any angle between vertical and horizontal (a deviated well), for example a vertical well may comprise a non-vertical component.

In embodiments, the gas hydrate may be pumped in the form of a slurry or slush such that a partial dewatering of the gas hydrates may form concentrated hydrate slurry containing around 75 volumes of gas per volume of hydrate, such as from about 50 to about 200 volumes of gas per volume of hydrate. The hydrate slurry comprises the gas hydrate and a solvent. Examples of solvents include a material that remains a liquid in the range of about −2° C. to about 30° C. Specific examples include, but are not limited to, water, brine, diesel, hydrocarbons, mineral oils and combinations thereof. The gas hydrate may have a density of about 400 to 950 kg/m³ and contains about 0.85 m³/m³ of water.

The injection of gas hydrate slurry into the treatment fluid may effectively increase the viscosity of the treatment fluid, such as for example, at least from about 2 to about 3 orders of magnitude, and therefore enhance proppant transport capacity by virtue of pumping gas hydrate slurries. Suspensions of solids in liquids tend to be more viscous than liquids without suspended solids due to presence of the solids in the dispersed phase. Such a result may be quantified by calculating the viscosity of gas hydrate slurry using the below formula:

η=η₀·f(φ); f(φ)>0

where η is the viscosity of the slurry, η₀ is the viscosity of the dispersing medium and f(φ) is a function of the volume of solids suspended. In this case, the gas hydrates are dispersed in a base fluid, aqueous or otherwise, and the enhanced proppant transport results in improved proppant placement in the fractures.

Furthermore, the solvent may be injected into a storage tank containing the gas hydrates and stored with the gas hydrates prior to introducing to the formation, or the gas hydrates may be mixed with the solvents after exiting the storage tank or vessel. The amount of solvent may be from about 5 to about 95 wt. %, such as, for example, from about 50 to about 90 wt. %, from about 60 to about 80 wt. % and from about 65 to about 80 wt. % based upon the total weight of slurry. The amount of gas hydrate in the slurry may be from about 5 to about 95 wt. % based upon the total weight of slurry, such as, for example, from about 5 to about 50 wt. %, from about 10 to about 40 wt. %, from about 10 to about 30 wt. % and from about 10 to about 20 wt. %, based upon the total weight of the slurry.

Either prior to injection in the wellbore, within the wellbore, or within the subterranean formation the gas hydrate expands and releases the containing gas. This gas may then be used in combination with additional materials to treat the subterranean formation.

Furthermore, the gas hydrates may be formed on the surface of the subterranean formation or at the subsea (underwater locations). If formed at the subsea, the gas hydrates may be extracted directly or indirectly from the ocean floor and introduced into the wellbore with one or more of the materials described herein to the subterranean formation. For subsea application, the gas hydrates may not have to be formed on the well site location. Instead, the existing hydrates may be removed from the surface and introduced into the subterranean formation.

As discussed above, gas hydrates form at high pressures and low temperatures wherever a suitable gas and water are present. Such conditions are prevalent in “cold-flow” pipelines, where the pipeline and wellstream fluids are unheated, and the wellstream fluids are allowed to flow through the pipeline at the low ambient temperatures often found in subsea environments.

As shown in FIG. 2, the gas hydrate stability zone (GHSZ) in sediments can be delineated on a temperature versus depth (pressure) profile with respect to the hydrothermal gradient (for subsea gas hydrates), geothermal gradient and the gas hydrate (or clathrate) phase boundary (for subsea sediments). The bottom simulating reflectors (BSR) indicate the base of the gas hydrate stability zone and are generally determined from seismic data. The position of the gas hydrate phase boundary is primarily a function of gas composition, but may also be controlled by pore fluid composition (e.g. presence of salts), pore size, and possibly sediment mineralogy. Hydrothermal and geothermal gradients are locality dependent, and can differ markedly with geographical location and tectonic setting. The predominant hydrate-forming gas is methane, with lesser CO₂ and hydrogen sulfide (H₂S), each of which are generally produced in-situ by microbial breakdown of sedimentary organic matter. In hydrocarbon-rich provinces, clathrates may contain a more deep-seated thermogenic gas component, generally in the form of ethane and propane, which, due to increased thermodynamic stability, can shift the GHSZ to considerably shallower depths.

Additional details regarding subsea hydrocarbon systems are described in U.S. Pat. No. 7,530,398 and U.S. Patent Application Pub. No. 2009/0020288 and 2013/0025632, the disclosures of which are incorporated by reference herein in their entirety.

The fluids of the present disclosure may be suitable for use in numerous subterranean formation types. For example, formations for which fracturing with the fluids of the present disclosure may be used include sand, sandstone, shale, coal, chalk, limestone, and any other hydrocarbon bearing formation.

The portion of the wellbore through which the fluid is injected into the treated zone can be open-hole (or comprise no casing) or can have previously received a casing. If cased, the casing is desirably perforated prior to injection of the fluid. Optionally, the wellbore can have previously received a screen. If it has received a screen, the wellbore can also have previously received a gravel pack, with the placing of the gravel pack optionally occurring above the formation fracture pressure (a frac-pack).

Techniques for injection of fluids with viscosities similar to those of the treatment fluids of the present disclosure are well known in the art and may be employed with the methods of the present disclosure. For example, known techniques may be used in the methods of the present disclosure to convey the fluids of the present disclosure into the subterranean formation to be treated.

In embodiments, the fluid may be driven into a wellbore by a pumping system that pumps one or more fluids into the wellbore. The pumping systems may include mixing or combining devices, wherein various components, such as fluids, solids, and/or gases maybe mixed or combined prior to being pumped into the wellbore. The mixing or combining device may be controlled in a number of ways, including, but not limited to, using data obtained either downhole from the wellbore, surface data, or some combination thereof. Methods of this disclosure may include using a surface data acquisition and/or analysis system, such as described in U.S. Pat. No. 6,498,988, incorporated herein by reference in its entirety. Packers or similar devices can be used to control flow of the fluid into the subterranean formation for which sealing is desired.

In embodiments, the gas hydrate slurry may be mixed with a treatment fluid. Prior to, during or after mixing, the combination of the gas hydrate slurry and the treatment fluid may form a foamed or energized fluid. Foams may be stabilized (1) with polymers which restrict the drainage of the foam boundaries or plateau borders or (2) a viscoelastic surfactant fluid containing wormlike micelles, such as those described in U.S. Pat. No. 5,964,295, the disclosure of which is incorporated by reference herein in its entirety. Additional information regarding various surfactants is described in U.S. Pat. Nos. 6,258,859, 7,084,095, 7,320,952, 7,341,980, 7,279,446, 7,387,987, 7,378,378, 7,507,693, 7,402,549, 7,387,986, 20070129262, 7,345,012, U.S. 20080051301, U.S. Pat. Nos. 7,565,929, 6,482,866 and 6,703,352, and U.S. Patent Application Pub. Nos. 2008/0051301 and 2007/0129262, the disclosures of which are incorporated by reference herein in their entireties. Foamable gel compositions are described for example in the U.S. Pat. Nos. 5,105,884, 5,203,834, 5,513,705 and 7,569,522, which are incorporated by reference herein in their entireties, wherein the polymer content is reduced at constant volume of the composition. Additional information regarding foamed or energized fluids is described in U.S. Pat. Nos. 2,029,478, 3,937,283, 6,192,985 and U.S. Patent Publication Nos. 20060178276, 20060166836, 20070238624, 20070249505, 20070235189, 20070215355, 20050045334, 20070107897 and 20090151952, each of which is incorporated by reference herein in its entirety.

Foamed fluids or foams are often used to fracture water sensitive formations such as those containing swellable clays. Alcoholic foams are especially useful as they minimize the amount of water required to create a foam, lower interfacial tension and improve recovery of the water from the formation. Foams also provide an energized flowback due to the presence of a compressible gas phase in the foam. Foams also have lower residual damage to the proppant pack created in the fracturing process as lower overall polymer may be appropriate in a foam versus an aqueous gelled fracturing fluid. Foams are also very useful for fracturing low fracture gradient wells because the hydrostatic column of foam is lighter than a column comprising aqueous or liquid hydrocarbon-based fluid. Reducing the pressure for these formations reduces the amount of fluid loss and can increase the fracture length achievable.

Disclosed herein are methods to energize a fracturing fluid with natural gas hydrates to promote fluid flowback and enhanced clean-up. The gas hydrates may be dissociated on their path to the reservoir or they may be injected directly into the reservoir. The dissociation of the gas hydrates (and the subsequent release of the gas) may be triggered by the increasing temperature with depth (geothermal gradient) and/or addition of chemicals, such as, for example, alcohols, such as for example, methanol, ethanol, glycerol, monoethylene glycol (MEG), diethylene glycol and triethylene glycol and various amines, as well as salts such as calcium chloride, potassium chloride, potassium bromide, all of which can be considered as gas hydrate inhibitors. Upon initiating flowback, the gas would enable enhanced drainage and lifting of the fracturing fluid. This action may promote improved removal of water and fracturing additives (including polymers) and could enhance retained proppant pack permeability. This method may also be used in depleted or underpressured reservoirs, which often require assistance to initiate flowback. This method has the additional benefit that the gas that is retrieved to the surface has commercial value as a produced hydrocarbon and does not dilute the produced natural gas with undesirable components such as nitrogen, carbon dioxide, etc. that might be used to form a conventional foamed fluid.

Foams or energized fluids comprise a gas phase, a liquid phase and a foaming surfactant that maintains the foam structure. Where stability at bottomhole conditions is desired, foams are often enhanced by addition of polymer or crosslinked-polymer stabilizers. Foams have very good leakoff properties and provide sufficient viscosity to transport proppant. The foam quality or percentage of gas phase is what distinguishes a “foamed fluid” from an “energized fluid”. For example, the foam quality or percentage of gas phase can vary from about 10 to about 52% for energized fluids, such as for example, from about 15 to about 40% and from about 20% to about 35%; and from 52 to 95% for foamed fluids, such as, for example, from about 55 to about 90%, and from about 65% to about 80%. Since the quality is calculated at bottomhole conditions, the amount of gas phase is much higher at standard conditions. Providing sufficient volumes of gas phase is one limitation of fracturing with foams. The use of hydrates which supply 168 standard cubic feet (scf) of methane per cubic foot of hydrate is a unique method for providing the larger quantities of gas at the surface. Foams formed from carbon dioxide may not have a gas phase, but the resulting foam may resemble one prepared with a gas phase in its properties. The phase is more accurately termed a “supercritical phase.”

Energized fluids have the ability to lower fluid density, which may be helpful for limiting water influx into underpressured reservoirs and to provide gas for helping flowback and cleanup. Using a saleable gas such as natural gas may allow the formation to be productive earlier than if nitrogen is used since nitrogen should be unloaded before the formation is placed in production as the natural gas may be considered pure enough for pipeline flow. Also, in theory, the client may recover the natural gas during flowback, so the net cost may be minimal as compared to the cost of purchased CO₂ or N₂. Also, foamed fluids may have much higher viscosity and can substitute for gelled fracturing fluids to carry proppant and enhance fracture width. In addition, foams may have minimal fluid loss that (1) favors fracture extension, (2) minimizes pad volumes and (3) is good for fluid-sensitive formations. Some shale formations have been shown to be much more sensitive to fluids, such as water, and result in softening of the rock, clay swelling and dissolution as well as fines generation.

In further embodiments, described herein is a method for promoting the rapid dissociation of hydrates under the conditions of injection pressures encountered during a well treatment. Hydrates formed on the surface of the subterranean formation may reduce gas pressurization requirements such as high pressure compressors and high pressure vessels or liquefied gas needed for typical foam formation. For instance, hydrates can be formed at reasonable surface temperatures of 50° F. and 800 psi, and maintaining the hydrates in an aqueous slurry in a moderate pressure vessel may be achievable. In this case, the gas hydrate slurry may be pumped using a standard injection pump rather than use of compressors. Gas hydrates may thus provide both a means to reduce expensive equipment such as high pressure compressors and to provide surface storage of the volume of gas needed for a treatment without the very low temperatures required for LNG.

The treatment fluid described herein may also include a gas hydrate inhibitor. Gas hydrate inhibitors have been employed in various oilfield operations as these materials shift the pressure-temperature (P-T) curve to the left, which has been interpreted as beneficial to prevent hydrate formation in oilfield pipelines and wellbores. Suitable examples of hydrate inhibitors include alcohols, such as for example, methanol, ethanol, glycerol, monoethylene glycol (MEG), diethylene glycol and triethylene glycol and various amines. The hydrate inhibitor may be present in the treatment fluid in an amount of from about 1 to about 80 wt. %, such as, for example, from about 10 to about 60%, from about 20 to 50%, based upon the total weight of the treatment fluid.

Additional examples of gas hydrate inhibitors include heavy brines having a salt concentration of from about 15 wt. % to about 90 wt. %, such as from about 20 wt. % to about 85 wt. %, from about 30 wt. % to about 70 wt. % and from about 40 wt. % to about 60 wt. %, based upon the concentration of inhibitors contained in the aqueous phase in equilibrium with the water phase. Specific examples of salts include alkali or alkaline earth halide salts, such as, for example, sodium chloride, potassium chloride, calcium chloride, magnesium fluoride, calcium bromide, cesium formate, potassium fluoride, and mixtures thereof.

FIG. 3 illustrates the phase boundary for a methane-water hydrate, along with formulations that also include various inhibitors, such as for example potassium chloride, ethylene glycol, glycerol and methanol. More specifically, (1) Locus 1 contains no inhibitor, (2) Locus 2 includes 15.8 wt. % KCl; (3) Locus 3 contains 18.1 wt. % ethylene glycol; (4) Locus 4 contains 18.1 wt. % glycerol; and (5) Locus 5 contains 16.7 wt. % methanol

The hydrate calculations were performed by using Hydrates 2011.1, a proprietary software program. The gas composition was fixed at methane for this analysis and various gas hydrate inhibitors were tested. As shown above, the P-T line shifted left towards lower temperatures for hydrate formation or melting, illustrating that hydrates may be formed at a lower temperature in the presence of inhibitors. At a pressure of 35 MPa (5076 psia), a methane hydrate will form at temperatures of 31.5° C. (88° F.) or lower and melt at temperatures exceeding 31.5° C. If the water contains 18.1 wt. % potassium chloride (KCl), the formation temperature is lowered to 15.7° C. (60.3° F.). If the inhibited hydrate is injected into a wellbore, the available temperature difference for melting the hydrate will be the wellbore temperature minus the melting temperature of the hydrate at the prevailing pressure. As pressure increases, the melting temperature also increases. With continued injection of cool surface fluids, the wellbore temperature may decrease from the native temperature, as predicted by a geothermal gradient, to a temperature that is 5 to 30 degrees Celsius warmer than the surface fluid temperature. This heat transfer may be largely controlled by injection rate with typical fracturing rates of 20-100 barrels per minute causing rapid drops in the wellbore temperature. Consequently, an inhibited hydrate or a case of mixing inhibitor with the hydrate downhole may allow greater heat transfer and facilitate dissociation as the melting temperature has been reduced by the addition of the gas hydrate inhibitor. For example, if the above mentioned pressure of 35 MPa is the well pressure, and the reservoir static temperature is 110° C., the differential temperature for heat flow rises from 78.5° C. for the case without inhibitor to 94.3° C. with inhibitor. Because heat flow is directly proportional to differential temperature, the hydrate will receive more heat in the case when the inhibitor is included and dissociation will happen quicker. The disassociation results in the release of methane gas needed for creating the foamed or energized fluid. By adjusting the inhibitor concentration and flow rate, the time for dissociation can be controlled.

The hydrate slurry can include an inhibitor when it is formed, but this will require lower temperature for storage at the surface. Alternatively, the inhibitor can be added by use of a separate stream meeting with the hydrate slurry at the wellhead, or the two streams may meet in the wellbore by injecting the two fluids through separate conduits. For example, the inhibitor could be injected down an annulus between the casing and production tubing while the hydrate slurry is injected down the production tubing. In another scenario, coiled tubing could be used wherein the separate fluids are injected into the production tubing and coiled tubing, respectively, and meet at the end of the coiled tubing. In this manner, the warming temperature gradient can be controlled by placement of the mixing zone between hydrate slurry and inhibitor solution at a desired location in the wellbore. This embodiment also reduces friction as the foam which forms at the mixing zone will experience higher frictional losses than the separate fluids. By placing the mixing zone nearer the perforations, friction is minimized as are surface pump pressures. U.S. Pat. No. 5,884,701, which is incorporated by reference herein in its entirety, discloses the use of coiled tubing for injecting separate fluids.

While the treatment fluids of the present disclosure are described herein as comprising the above-mentioned components, it should be understood that the fluids of the present disclosure may optionally comprise other chemically different materials. Furthermore, the components of the treatment fluid described in detail above (or an entirely different treatment fluid such that one or more different treatment fluids are used to treat the formation) may include a linear or crosslinked gel. For example, if two different treatment fluids are employed, a first treatment fluid may contain either the gas hydrate slurry or the materials to form the crosslinked gel and the second treatment fluid may contain the materials needed to form the crosslinked gel or the gas hydrate slurry. The first or second treatment may or may not contain the same materials. Furthermore, if the gel is crosslinked, it may also contain a crosslinkable component, a carrier fluid and a crosslinker.

The treatment fluids or compositions suitable for use in the methods of the present disclosure comprise a crosslinkable component. As discussed above, a “crosslinkable component,” as the term is used herein, is a compound and/or substance that comprises a crosslinkable moiety. However, the crosslinkable components can be used without the presence of a crosslinker. In this case, the gel form would be a linearized gel instead of a crosslinked gel. For example, the crosslinkable components may contain one or more crosslinkable moieties, such as a carboxylate and/or a cis-hydroxyl (vicinal hydroxyl) moiety that is able to coordinate with the reactive sites of the crosslinker. The reactive sites of the crosslinkable component may be, for example, the site where the metals (such as Al, Zr and Ti and/or other Group IV metals) or boron are present. The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenan, a succinoglycan, a xanthan, a diutan, a hydroxylethylguar. a hydroxypropyl guar, a carboxymethylhydroxyethyl guar, a carboxymethylhydroxypropylguar, a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2-methyl-propane sulfonic acid, acrylic acid, acrylamide, or derivatives thereof. In embodiments, the crosslinkable components may be present at about 0.01% to about 4.0% by weight based on the total weight of the treatment fluid, such as at about 0.10% to about 2.0% by weight based on the total weight of the treatment fluid.

The term “derivative” herein refers, for example, to compounds that are derived from another compound and maintain the same general structure as the compound from which they are derived.

The treatment fluid of the present disclosure may be a solution initially having a very low viscosity that can be readily pumped or otherwise handled. For example, the viscosity of the fluid may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature, such as from about 4° C. to 2° C. to about 246° C., or from about 10° C. to about 149° C., or from about 25° C. to about 121° C., or from about 32° C. to about 107° C.

Crosslinking the fluid of the present disclosure generally increases its viscosity. As such, having the composition in the uncrosslinked/unviscosified state allows for pumping of a relatively less viscous fluid having relatively low friction pressures within the well tubing, and the crosslinking may be delayed in a controllable manner such that the properties of thickened crosslinked fluid are available at the rock face instead of within the wellbore. Such a transition to a crosslinked/uncrosslinked state may be achieved over a period of minutes or hours based on the particular molecular make-up of the crosslinker, and results in the initial viscosity of the treatment fluid increasing by at least an order of magnitude, such as at least two orders of magnitude.

Suitable solvents for use with the fluid in the present disclosure may be aqueous or organic based. Aqueous solvents may include at least one of fresh water, sea water, brine, mixtures of water and water-soluble organic compounds and mixtures thereof. Organic solvents may include any organic solvent which is able to dissolve or suspend the various components of the treatment fluid, such as, for example, organic alcohols, such as, isopropanol.

In some embodiments, the treatment fluid may initially have a viscosity similar to that of the aqueous solvent, such as water. An initial water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The rate at which the viscosity of the treatment fluid changes may be varied by the choice of the crosslinker and polymer employed in the treatment fluid. The viscosity of the treatment fluid may also be varied by increasing or decreasing the amount of solvent relative to other components, or by other techniques, such as by employing viscosifying agents. In embodiments, the solvent, such as an aqueous solvent, may represent up to about 95 weight percent of the treatment fluid, such as in the range of from about 85 to about 95 weight percent of the treatment fluid, or from about 90 to about 95 weight percent of the treatment fluid.

In some embodiments, the treatment fluid may initially have a viscosity similar to that of the aqueous solvent, such as water or a more viscous base fluid formed by a linear polymer gel. Viscosity can be increased further by formation of a foam or energized fluid in the wellbore. An example is when the gas hydrates in the gas hydrate slurry partially or entirely dissociate or melt, thereby releasing the natural gas in the presence of surfactant. The flow within the wellbore coupled with the sporadic release upon melting may provide sufficient energy to create a foam. Moreover, the viscosity increases can vary from about 25 to 300 mPa·s or about 20 to 500 mPa·s or even 15 to 1000 mPa·s., when the fluid is foamed or energized to a quality from 10 to 90% or 20 to 80% or 30 to 75%, with higher viscosities achievable for higher quality foams. As previously mentioned, the point in the wellbore where foam generation occurs can be set by the heat transfer and time of melting of the hydrates. Inclusion of the inhibitors can be used advantageously to design the point of melting.

The crosslinking agent in the treatment fluids of the present application may comprise a polyvalent metal ion that is capable of crosslinking at least two molecules of the crosslinkable component. Examples of suitable metal ions include, but are not limited to, zirconium IV, titanium or aluminum and/or other Group IV metals. Other suitable crosslinkers can contain boron. The metal ions may be provided by any compound that is capable of producing one or more of these ions. Examples of such compounds include zirconyl chloride, zirconium sulfate and triethanol titanate.

In some embodiments, the crosslinking agent is present in the treatment fluid in an amount from about 0.1 to about 1.0% by volume. In some embodiments, the crosslinking agent comprises about 0.3% by volume of the fluid. Considerations one may take into account in deciding how much crosslinking agent may be added include the temperature conditions of a particular application, the composition of the gelling agent used, and/or the pH of the treatment fluid. Other considerations may be evident to one skilled in the art.

The crosslinking agent may also comprise a stabilizing agent operable to provide sufficient stability to allow the crosslinking agent to be uniformly mixed into the polymer solution. Examples of suitable stabilizing agents include, but are not limited, to propionate, acetate, formate, triethanolamine, and triisopropanolamine. Additional stabilizing agents are discussed below.

The treatment fluid may not begin to build viscosity before it is placed into the desired portion of a subterranean formation. If it builds viscosity too quickly, this would interfere with pumping and placement of the crosslinkable polymer composition into the formation. However, for some particular crosslinkers, such as, for example, dual-metal crosslinkers, the viscosity may be developed early for sufficient proppant transport prior to entering the formation.

As discussed above, a first treatment fluid comprised of at least a crosslinkable component, a carrier fluid and a crosslinkable material may be introduced into the subterranean formation. At some point in the subterranean formation, the crosslinkable component and the crosslinkable material may crosslink to form a gelled fluid, thus resulting in a fracture in the subterranean formation. After forming the fracture, another (or second) treatment fluid comprised may be introduced into the subterranean formation. Furthermore, prior to or during the introduction at least a gas hydrate slurry, at least a portion, such as, for example, at least 75% of the gas hydrates remain stable and do not release gas until exposed to the subterranean formation. Such a process may improve clean-up of the crosslinked fluid during flowback.

In embodiments, the fluid may further comprise stabilizing agents, surfactants, diverting agents, or other additives. Additionally, the treatment fluid may comprise a mixture of various other crosslinking agents, and/or other additives, such as fibers or fillers, provided that the other components chosen for the mixture are compatible with the intended use of forming a crosslinked three dimensional structure that at least partially transports proppant. In embodiments, the treatment fluid of the present disclosure may further comprise one or more components such as, for example, a gel breaker, a buffer, a proppant, a clay stabilizer, a gel stabilizer, and a bactericide. Furthermore, the treatment fluid or treatment fluid may comprise buffers, pH control agents, oxygen scavengers and various other additives added to promote the stability or the functionality of the fluid. The treatment fluid may be based on an aqueous or non-aqueous solution. The components of the treatment fluid may be selected such that they may or may not react with the subterranean formation that is to be fractured.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the formation of a three dimensional structure upon substantial completion of the crosslinking reaction. For example, the fluid or treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure after its formation downhole. Typical stabilizing agents include buffering agents, such as water-soluble bicarbonate salts, such as sodium bicarbonate, carbonate salts, phosphate salts, or mixtures thereof, among others; and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the crosslinker.

Buffering agents may be added to the treatment fluid in an amount from about 0.05 wt. % to about 10 wt. %, and from about 0.1 wt. % to about 2 wt. %, based upon the total weight of the treatment fluid. Additional chelating agents may be added to the fluid or treatment fluid to at least about 0.75 mole per mole of metal ions expected to be encountered in the downhole environment, such as at least about 0.9 mole per mole of metal ions, based upon the total weight of the fluid or treatment fluid.

Surfactants can be added to promote dispersion or emulsification of components of the fluid, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. No. 6,703,352, U.S. Pat. No. 6,239,183, U.S. Pat. No. 6,506,710, U.S. Pat. No. 7,303,018, U.S. Pat. No. 6,482,866, U.S. Pat. No. 7,998,909 and U.S. Pat. No. 8,207,094, each of which are incorporated by reference herein in their entirety, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944 (available from Baker Petrolite of Sugar Land, Tex.). A surfactant may be added to the fluid in an amount in the range of about 0.01 wt. % to about 10 wt. %, such as about 0.1 wt. % to about 2 wt. % based upon total weight of the treatment fluid.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

The treatment fluids described herein may also include one or more inorganic salts. Examples of these salts include water-soluble potassium, sodium, and ammonium salts, such as potassium chloride, ammonium chloride, choline chloride, or tetramethyl ammonium chloride (TMAC). Additionally, sodium chloride, calcium chloride, potassium chloride, sodium bromide, calcium bromide, potassium bromide, sodium sulfate, calcium sulfate, sodium phosphate, calcium phosphate, sodium nitrate, calcium nitrate, cesium chloride, cesium sulfate, cesium phosphate, cesium nitrate, cesium bromide, potassium sulfate, potassium phosphate, potassium nitrate salts may also be used. Any mixtures of the inorganic salts may be used as well. The inorganic salt may be added to the fluid in an amount of from about 1 wt % to about 99 wt. % based upon total weight of the treatment fluid.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing or even eliminating the use of conventional fluid loss additives. Latex resins or polymer emulsions may be incorporated as fluid loss additives. Shear recovery agents may also be used in embodiments.

The above fluids may also comprise a breaker. The purpose of this component is to “break” or diminish the viscosity of the fluid so that this fluid is more easily recovered from the formation during cleanup. With regard to breaking down viscosity, inorganic or organic oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppant particles carried by the treatment fluid remain in the fracture created, thus propping open the fracture when the fracturing pressure is released and the well is put into production. Proppant particles can have any shape, including but not limited to spherical and rod-like. Proppant particles might be filled entirely with a solid substrate or contain hollow spaces within. Suitable proppant materials include, but are not limited to, sand, walnut shells, sintered bauxite, glass beads, ceramic materials, nanocomposite beads, naturally occurring materials, or similar materials. Mixtures of proppants can be used as well. If sand is used, it may be from about 20 to about 100 U.S. Standard Mesh in size, although other sizes above and below this range can be used. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc.

The concentration of proppant in the fluid can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the fluids to achieve a variety of properties including improving particle suspension, and particle transport capabilities, and gas phase stability. Fibers used may be hydrophilic or hydrophobic in nature. Fibers can be any fibrous material, such as, for example, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in fluids, the fiber component may be included at concentrations from about 1 to about 100 grams per liter of the liquid phase of the fluid, such as a concentration of fibers from about 2 to about 30 grams per liter of liquid, or from about 2 to about 20 grams per liter of liquid.

Embodiments may further use fluids containing other additives and chemicals that are known to be commonly used in oilfield applications by those skilled in the art. These include materials such as surfactants in addition to those mentioned hereinabove, breaker aids in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

As used herein, the term “alcohol stabilizer” is used in reference to a certain group of organic molecules substantially or completely soluble in water containing at least one hydroxyl group, which are susceptible of providing thermal stability and long term shelf life stability to aqueous zirconium complexes. Examples of organic molecules referred as “alcohol stabilizers” include but are not limited to methanol, ethanol, n-propanol, isopropanol, n-butanol, tert-butanol, ethyleneglycol monomethyl ether, and the like.

Furthermore, one or more of the chemicals identified above may be encapsulated to provide a delayed release of the oilfield chemicals into the surrounding fluid or material such that the oilfield chemical is liberated after entering the formation (or the fracture). Additional details regarding encapsulation are described in U.S. Patent Application Pub. Nos. 2010/0307744; 20100270031 and 2008/0109490, the disclosure of which are incorporated by reference herein in their entirety.

The foregoing is further illustrated by reference to the following examples, which are presented for purposes of illustration and are not intended to limit the scope of the present disclosure.

### EXAMPLES

### Example 1

### Gas Hydrate Formation

The example begins by first thoroughly cleaning the PVT cell, followed by the evacuation, and charging with approximately 3 mL of a prepared aqueous solution containing the brine to be used in the treatment. This brine can be freshwater, produced water, or a brine created by adding salt to the water source and the specified amount of inhibitor (KHI)/anti-agglomerate (AA). Following this step, add the single phase gas mixture from the stock cylinder by displacement using a hand operated positive displacement pump. The volume of the gas to aqueous liquid will be maintained at a specified ratio.

Using the software (Hydrates 2011.1) to predict the hydrate formation window, adjust the pressure and temperature to be within the range of expected hydrate formation until a relatively large amount of solid crystals have formed. The temperature is then increased slowly until the bulk of the crystals have melted. The precise value of the temperature for incipient hydrate formation is determined visually by alternately forming and decomposing individual crystals while making minor changes in the temperature of the cell contents. During the test, the system pressure is maintained at the specified value by the displacement pump. The hydrate temperature reported is the average between the observed formation and decomposition temperature. These are normally within about 0.2° C. (0.4° F.) of each other.

After the hydrate dissociation temperature is established, the cell temperature is increased by 0.2° C. (0.4° F.) at a time to determine the hydrate disappearance temperature. At each temperature increment, the cell contents are agitated by the mixer to ensure proper thermal and mass equilibration.

The inhibitor tests at pressure and temperature for different concentrations of KHI and AA solutions are also performed in the cell connected with high pressure microscope to determine the formation of hydrate particles based on a 24-hr test period. The cell is continuously stirred for 24 hours. Monitoring for hydrate formation is conducted. Approximately 5 cc of the sample is pushed from the PVT cell into the glass viewing cell where black and white pictures are captured by a high pressure microscope coupled with a charge-coupled device (CCD) camera. Whether any hydrate formed or not, the experiment is terminated after capturing the pictures (i.e. 24 hours). The same protocol is repeated for each inhibitor.

### Example 2

### Gas Hydrate Foaming

The objective is to form a 25% energized fluid using natural gas hydrates and a surfactant. The hydrate slurry and the surfactant are mixed inline and pumped into the wellhead with a typical fleet of fracturing pumps. The hydrate is pre-slurried into a pressure tank with conditions of 5.5 MPa (800 psig) and 10° C. (50° F.) and contains 50% hydrate in a 15.8% KCl brine.

While pumping the slurry at a rate of 17 barrels per minute and the surfactant at a rate of 0.13 barrel per minute into the wellhead, the pressure is increased to 5000 psi. As the fluid is pumped down the well, the temperature is increased to above the melting point of 16° C. (61° F.) and warms to an eventual temperature of 66° C. (150° F.) in the fracture. At this condition, the fracturing fluid has a quality of about 25%. As the fluid warms, the evolved gas is incorporated into an energized fluid. This energized fluid will provide gas during flowback to improve the cleanup of the fracture.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Further, those skilled in the art will readily appreciate that many modifications are possible in the example embodiments without materially departing from WELL STIMULATION WITH NATURAL GAS HYDRATES. Accordingly, all such modifications are intended to be included within the scope of this disclosure as defined in the following claims

What is claimed is:

1. A method of treating a subterranean formation penetrated by a wellbore, the method comprising:
introducing a treatment fluid comprised of at least a gas hydrate slurry to the subterranean formation.

2. The method of claim 1, wherein the gas hydrate slurry is comprised of a gas hydrate and a solvent.

3. The method of claim 2, wherein the gas hydrate is comprised of at least one gas hydrate forming constituent selected from the group consisting of methane, ethane, propane, butane, neopentane, ethylene, propylene, isobutylene, cyclopropane, cyclobutane, cyclopentane, cyclohexane, benzene, oxygen, nitrogen, hydrogen sulfide, carbon dioxide, sulfur dioxide, chlorine, and combinations thereof.

4. The method of claim 2, wherein the solvent may be aqueous or organic based.

5. The method of claim 1, wherein the introduction of the treatment fluid further comprises:
preparing the gas hydrate slurry on a surface of the subterranean formation, and
injecting the gas hydrate slurry into the treatment fluid.

6. The method of claim 1, wherein the gas hydrate slurry contains from about 50 to about 200 volumes of gas per volume of hydrate.

7. The method of claim 1, wherein the treatment fluid is a foamed fluid or an energized fluid comprising at least one gas.

8. The method of claim 7, wherein the at least one gas is nitrogen, carbon dioxide, methane or combinations thereof.

9. The method of claim 1, wherein the treatment fluid further comprises a liquefied gas.

10. The method of claim 1, wherein the treatment fluid further comprises a gas hydrate inhibitor.

11. The method of claim 1, wherein the treatment fluid further comprises a crosslinkable component.

12. The method of claim 11, wherein the treatment fluid further comprises a crosslinkable material.

13. The method of claim 1, wherein a hydrate-forming constituent of the gas hydrate slurry is natural gas.

14. The method of claim 1, wherein the introduction of the gas hydrate slurry effectively cools down the wellbore fluids and/or decreases the bottomhole treating temperature

15. A method of treating a subterranean formation penetrated by a wellbore, the method comprising:
introducing a treatment fluid comprised of at least a gas hydrate slurry to the subterranean formation,
wherein the introduction of the gas hydrate slurry effectively increases the viscosity of the treatment fluid at least from about 2 to about 3 orders of magnitude, which enhances a proppant transport capacity of the treatment fluid.

16. A method of treating a subterranean formation penetrated by a wellbore, the method comprising:
introducing a first treatment fluid comprised of at least a crosslinkable component, a carrier fluid and a crosslinkable material to the subterranean formation,
forming at least one fracture within the subterranean formation with the first treatment fluid, and
after the forming of the fracture, introducing a second treatment fluid comprised of at least a gas hydrate slurry.

17. The method of claim 16, wherein during the introduction of the second treatment fluid, at least a portion of a plurality of gas hydrates of the gas hydrate slurry remain stable and upon exposure to the subterranean formation, the plurality of gas hydrates release gas for improved cleanup.

18. The method of claim 16, wherein at least a portion of gas hydrates in the gas hydrate slurry begin to disassociate during the introducing of the second treatment fluid to provide a higher quality energized or foamed fluid with higher viscosity and stability.

19. The method of claim 18, wherein the disassociation occurs in the wellbore.

20. The method of claim 16, the method further comprising introducing a gas hydrate inhibitor in the second treatment fluid.
